(19) United States
(12) Patent Application Publication
(10) Pub. No.: US 2025/0331669 A1
(43) Pub. Date: Oct. 30, 2025

(54) Parcel Delivery Security Container and a Method and System Therefor

(71) Applicant: Stuart Roane, III, Marion, IN (US)

(72) Inventor: Stuart Roane, III, Marion, IN (US)

(21) Appl. No.: 18/646,014

(22) Filed: Apr. 25, 2024

(51) Int. Cl. A47G 29/14; A47G 29/30; G07C 9/00

(52) U.S. Cl. CPC A47G 29/141; A47G 29/30; G07C 9/00912; A47G 2029/143

(57) ABSTRACT

A parcel delivery security container includes a bottom panel, side panels, a lid, an electromagnetic lock assembly, an input device, a barcode scanner, a microprocessor, and a power source. The side panels are transverse to the bottom panel to form an open-ended compartment. The lid is pivotably connected to one of the side panels to selectively open and close the compartment. The electromagnetic lock assembly releasably locks the lid when closed. The input device is on an outer surface of the security container to permit a user to enter information. The barcode scanner is on an outer surface of the security container to scan barcodes on parcels. The microprocessor is operatively connected to the input device, the barcode scanner, and the electromagnetic lock assembly to control locking and unlocking thereof. The power is operatively connected to the input device, the barcode scanner, the electromagnetic lock assembly, and the microprocessor.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to parcel delivery boxes and more particularly pertains to a new parcel delivery security container for securely containing and protecting delivered parcels from damage or theft.

### (2) Description of Related Art Including Information Disclosed Under 37 CFR 1.97 and 1.98

The prior art relates to parcel delivery boxes. The prior art, as best understood, does not disclose parcel delivery security container that includes an input device, a barcode scanner, and an electromagnetic lock assembly.

### BRIEF SUMMARY OF THE INVENTION

An embodiment of the disclosure meets the needs presented above in a parcel delivery security container generally comprising a bottom panel, side panels, a lid, an electromagnetic lock assembly, an input device, a barcode scanner, a microprocessor, and a power source. The side panels are transverse to the bottom panel to form an open-ended compartment. The lid is pivotably connected to one of the side panels to selectively open and close the compartment. The electromagnetic lock assembly releasably locks the lid when closed. The input device is on an outer surface of the security container to permit a user to enter information. The barcode scanner is on an outer surface of the security container to scan barcodes on parcels. The microprocessor is operatively connected to the input device, the barcode scanner, and the electromagnetic lock assembly to control locking and unlocking thereof. The power is operatively connected to the input device, the barcode scanner, the electromagnetic lock assembly, and the microprocessor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a parcel delivery security container according to an embodiment of the disclosure.

FIG. 2 is a top view of an embodiment of the disclosure.

FIG. 3 is a side view of an embodiment of the disclosure.

FIG. 4 is a bottom view of an embodiment of the disclosure.

FIG. 5 is a front view of an embodiment of the disclosure.

FIG. 6 is a cross-sectional view of an embodiment of the disclosure.

FIG. 7 is a view of an embodiment of the disclosure in use.

FIG. 8 is a block diagram of components of an embodiment of the disclosure.

### DETAILED DESCRIPTION OF THE INVENTION

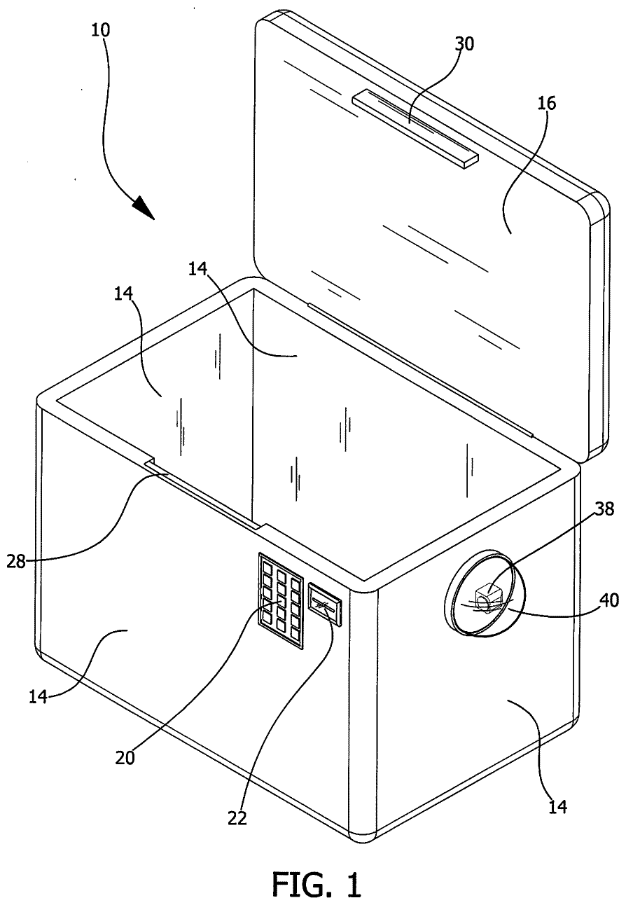

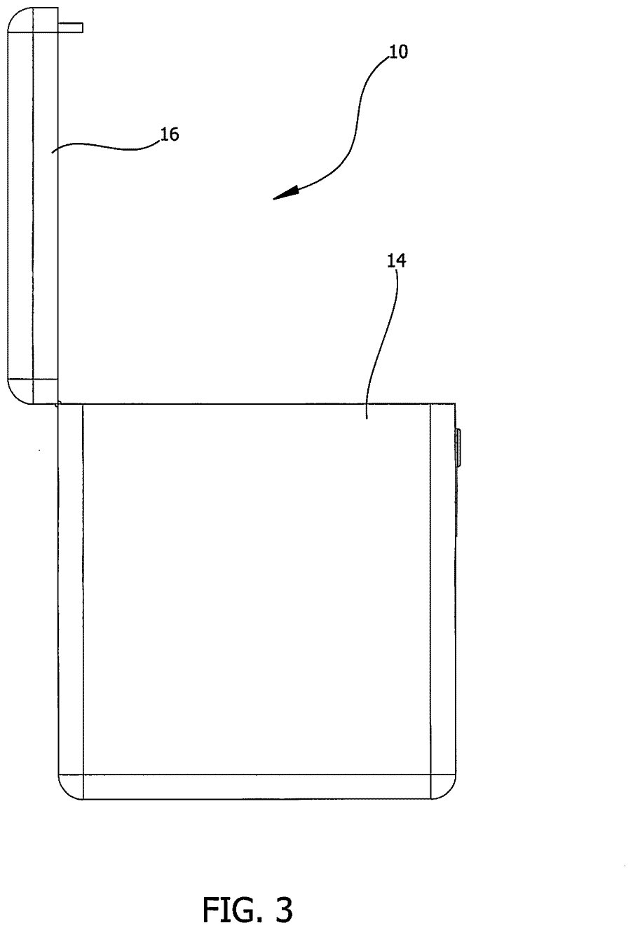

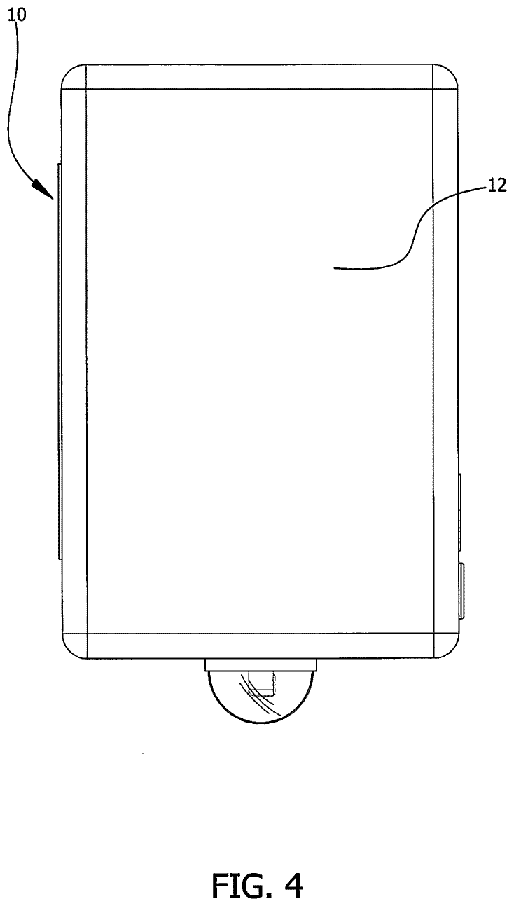

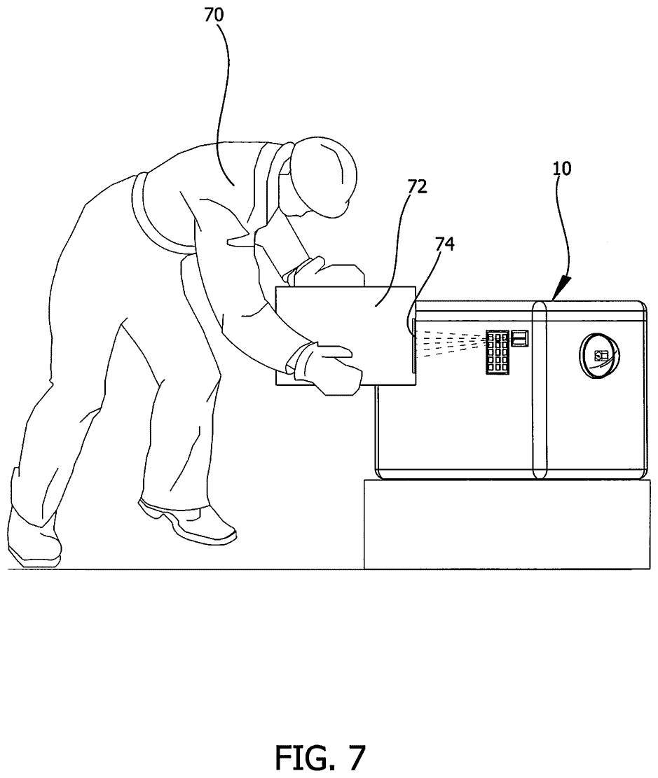

With reference now to the drawings, and in particular to FIGS. 1 through 8 thereof, a new parcel delivery security container embodying the principles and concepts of an embodiment of the disclosure and generally designated by the reference numeral 10 will be described.

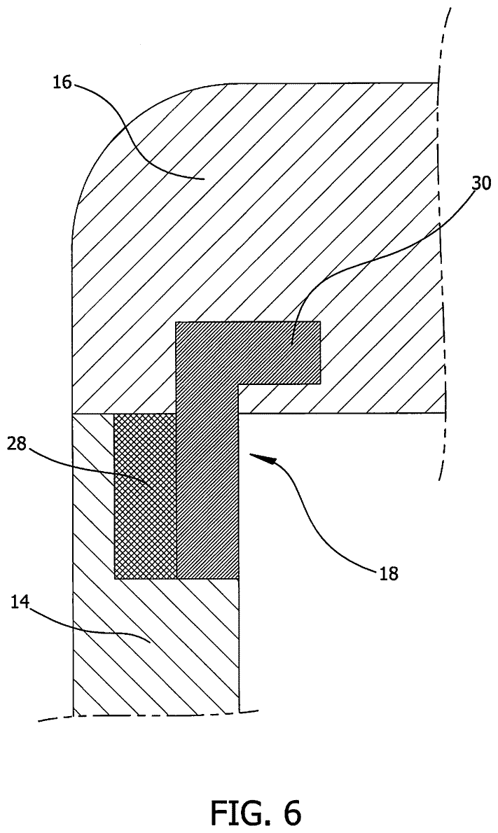

As best illustrated in FIGS. 1 through 8, the parcel delivery security container 10 generally comprises A parcel delivery security container 10 includes a bottom panel 12, side panels 14, a lid 16, an electromagnetic lock assembly 18, an input device 20, a barcode scanner 22, a microprocessor 24, and a power source 26. The side panels 14 are transverse to the bottom panel 12 to form an open-ended compartment. The lid 16 is pivotably connected to one of the side panels 14 to selectively open and close the compartment. The electromagnetic lock assembly 18 releasably locks the lid 16 when closed. As best seen in FIGS. 1 and 6, the electromagnetic lock assembly 18 includes an electromagnet 28 mounted on an inner surface of one of the side panels 14 and an armature 30 mounted on an inner surface of the lid 16, though these positions could be reversed.

The input device 20 is on an outer surface of the security container 10 to permit a user to enter information. As best seen in FIGS. 1, the input device 20 is an alphanumeric keypad, though a digital device could be used. A voice-activated input could also be used. The barcode scanner 22 is also on an outer surface of the security container 10 to scan barcodes on parcels. As best seen in FIG. 1, each of the input device 20 and the barcode scanner 22 are positioned on a side panel 14 at the front of the security container 10, though other locations, such as other side panels 14 or the lid 16, are possible variations.

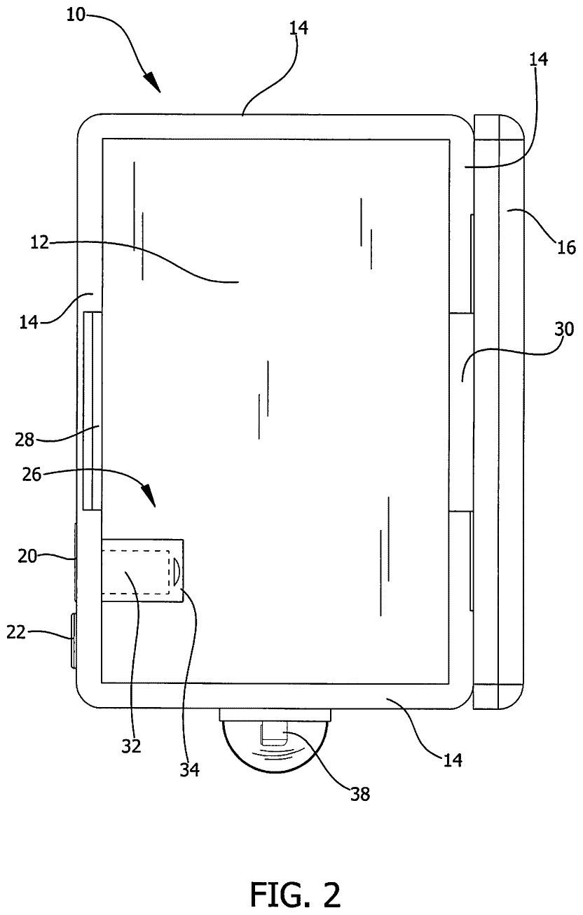

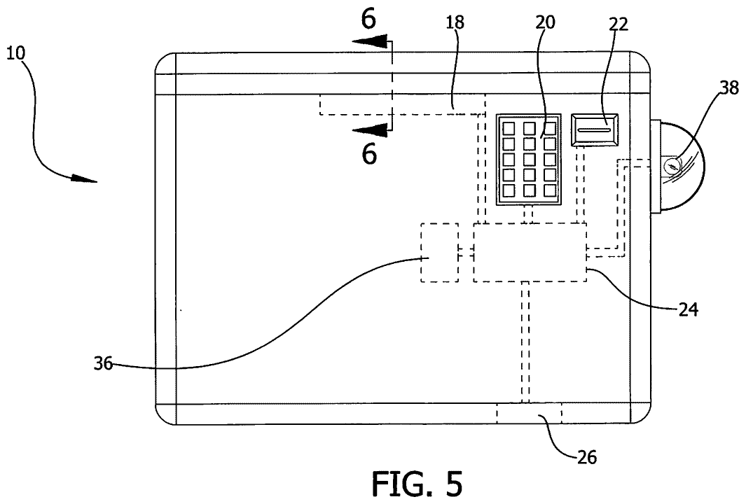

As best seen in FIG. 5, the microprocessor 24 is operatively connected to the input device 20, the barcode scanner 22, and the electromagnetic lock assembly 18 to control locking and unlocking thereof. The microprocessor 24 includes a memory to store information, such as at least a security code to unlock the security container 10 and barcode information for parcels to be received by a user. The power source 26 is operatively connected to the input device 20, the barcode scanner 22, the electromagnetic lock assembly 18, and the microprocessor 24. The power source 26 could be located anywhere inside the security container 10, such as on the bottom of the compartment or in one of the bottom panel 12 or the side panels 14, in order to prevent tampering with the power source 26 by persons other than the user. As shown in FIG. 2, the power source 26 includes batteries 32 stored in the bottom panel 12 and an access cover 34 integrally formed with an inner surface of the bottom panel 12.

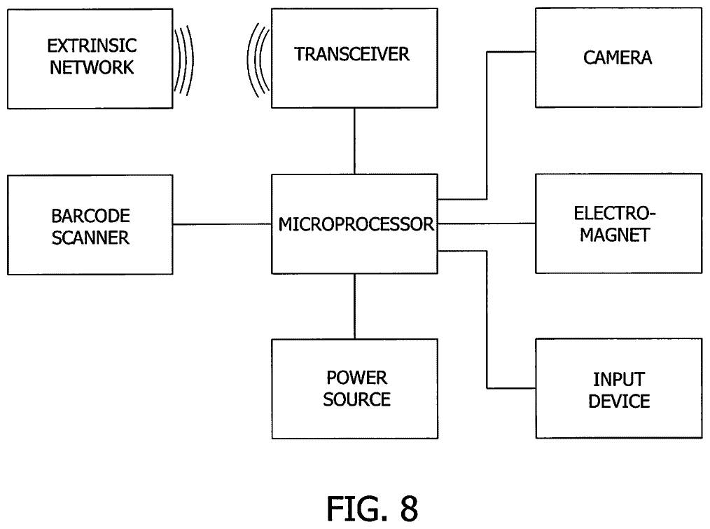

As best seen in FIG. 5, a transceiver 36 is operatively connected to the power source 26 and the microprocessor 24 to wirelessly connect to a remote device to receive and transmit data. As shown in the diagram in FIG. 8, the transceiver 36 allows wireless connection to an extrinsic network or database. In one possible embodiment, the extrinsic network includes a computer application that is storable on a remote electronic device to wirelessly connect to the microprocessor 24 to permit a user to input and receive information relating to the operation of the security container 10.

A camera 38 is operatively connected to the microprocessor 24 and the power source 26 and positioned on an outer surface of the security container 10 to obtain video of an area adjacent the security container 10. As best seen in FIG. 1, the camera 38 is mounted on one of the side panels 14, though it could be located elsewhere. In one possible embodiment, the camera 38 is a wide angle or fish eye camera 38. Also as seen in FIG. 1, the camera 38 includes a tamper-proof housing 40 to minimize or prevent disabling of the camera 38.

The parcel delivery security container 10 is used to prevent damage or theft of parcels delivered to a user. Unless the lid 16 is already closed, the user closes the lid 16 and locks the lid 16 in place with the electromagnetic lock assembly 18, which is always in an activated state, though the security container 10 could be designed such that the user could input a command to deactivate it until the user reactivates it. The security container 10 is located in an area accessible to a delivery person 70. When the delivery person 70 brings a parcel 72, he or she scans a barcode 74 of the parcel 72, such as a tracking identification barcode, with the barcode scanner 22. The microprocessor 24 then compares the scanned barcode information with stored barcode information corresponding to at least one parcel to be received by the user. The stored barcode information could be obtained in a number of different ways, such as by direct input via the input device 20 on the security container 10, wireless input via the computer application on a remote electronic device, such as a computer or smartphone, or by accessing an external database that has the user's parcel information. When the scanned barcode information matches stored barcode information, the microprocessor 24 sends a command to temporarily deactivate the electromagnetic lock assembly 18. The delivery person 70 can now open the lid 16 while the electromagnetic lock assembly 18 is temporarily deactivated and insert the parcel 72 into the compartment. The electromagnetic lock assembly 18 is automatically reactivated after a set time so that when the delivery person closes the lid 16, the lid 16 re-locks. When the user is ready to retrieve his or her parcel, the user inputs a command and temporarily deactivates the electromagnetic lock assembly 18 so that the user can open the lid 16 and retrieve the parcel. The command could be input via the input device 20 on the security container 10 or via the computer application. The camera 38 can be used as security device to monitor the activity around the security container 10 or as way for the user to know when a parcel has been delivered. Since the security container 10 automatically locks, a safety sensor could be positioned inside the compartment to detect movement within the container, such as if a small child or animal were to become locked inside the container, which safety sensor would cause the microprocessor 24 to automatically deactivate the electromagnetic lock assembly 18 so that the child or animal could push open the lid 16 and escape.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A parcel delivery security container comprising:
a bottom panel and side panels transverse to said bottom panel to form an open-ended compartment;
a lid pivotably connected to one of said side panels to selectively open and close said compartment;
an electromagnetic lock assembly to releasably lock said lid when closed;
an input device disposed on an outer surface of the security container to permit a user to enter information:
a barcode scanner disposed on an outer surface of the security container to scan barcodes on parcels;
a microprocessor operatively connected to said input device, said barcode scanner, and said electromagnetic lock assembly to control locking and unlocking of said electromagnetic lock assembly; and
a power source operatively connected to said input device, said barcode scanner, said electromagnetic lock assembly, and said microprocessor.

2. The parcel delivery security container of claim 1, wherein the security container further comprises a camera operatively connected to said microprocessor and said power source and disposed on an outer surface of the security container to obtain video of an area adjacent the security container.

3. The parcel delivery security container of claim 2, wherein the security container further comprises a transceiver operatively connected to said power source and said microprocessor to wirelessly connect to a remote device to receive and transmit data.

4. The parcel delivery security container of claim 3, wherein said microprocessor comprises a memory to store information comprising at least a command to unlock the security container and barcode information for parcels to be received by a user.

5. The parcel delivery security container of claim 4, wherein said input device comprises an alphanumeric keypad.

6. The parcel delivery security container of claim 5, wherein said electromagnetic lock assembly comprises an electromagnet mounted on an inner surface of one of said side panels and an armature mounted on an inner surface of said lid.

7. The parcel delivery security container of claim 6, wherein said camera is mounted on one of said side panels and comprises a wide angle or fish-eye camera.

8. The parcel delivery security container of claim 7, wherein said camera comprises a tamper-proof housing to minimize or prevent disabling of said camera.

9. The parcel delivery security container of claim 8, wherein said power source comprises batteries stored in said bottom panel and an access cover integrally formed with an inner surface of said bottom panel.

10. The parcel delivery security container of claim 1, wherein the security container further comprises a transceiver operatively connected to said power source and said microprocessor to wirelessly connect to a remote device to receive and transmit data.

11. The parcel delivery security container of claim 1, wherein said microprocessor comprises a memory to store information comprising at least a command to unlock the security container and barcode information for parcels to be received by a user.

12. The parcel delivery security container of claim 1, wherein said input device comprises an alphanumeric keypad.

13. The parcel delivery security container of claim 1, wherein said electromagnetic lock assembly comprises an electromagnet mounted on an inner surface of one of said side panels and an armature mounted on an inner surface of said lid.

14. The parcel delivery security container of claim 2, wherein said camera is mounted on one of said side panels and comprises a wide angle or fish-eye camera.

15. The parcel delivery security container of claim 2, wherein said camera comprises a tamper-proof housing to minimize or prevent disabling of said camera.

16. The parcel delivery security container of claim 1, wherein said power source comprises batteries stored in said bottom panel and an access cover integrally formed with an inner surface of said bottom panel.

17. A method of using the parcel delivery security container of claim 1, said method comprising the steps of:
activating said electromagnetic lock assembly to releasably lock said lid when closed;
scanning a barcode of a parcel with said barcode scanner;
comparing with said microprocessor said scanned barcode information with stored barcode information corresponding to at least one parcel to be received by a user;
temporarily deactivating said electromagnetic lock assembly when said scanned barcode information matches stored barcode information;
opening said lid while said electromagnetic lock assembly is temporarily deactivated and inserting said parcel into said compartment;
automatically reactivating said electromagnetic lock assembly after a set time;
closing said lid and re-locking said lid;
inputting a command and temporarily deactivating said electromagnetic lock assembly; and
opening said lid and retrieving said parcel.

18. A parcel delivery security system comprising:
a container comprising:
a bottom panel and side panels transverse to said bottom panel to form an open-ended compartment;
a lid pivotably connected to one of said side panels to selectively open and close said compartment;
an electromagnetic lock assembly to releasably lock said lid when closed;
an input device disposed on an outer surface of the security container to permit a user to enter information:
a barcode scanner disposed on an outer surface of the security container to scan barcodes on parcels;
a microprocessor operatively connected to said input device, said barcode scanner, and said electromagnetic lock assembly to control locking and unlocking of said electromagnetic lock assembly;
a power source operatively connected to said input device, said barcode scanner, said electromagnetic lock assembly, and said microprocessor; and
a transceiver operatively connected to said power source and said microprocessor to wirelessly connect to a remote device to receive and transmit data; and
a computer application storable on a remote electronic device to wirelessly connect to said microprocessor to permit a user to input and receive information relating to the operation of the security container.
